(19) United States
(12) Patent Application Publication
(10) Pub. No.: US 2011/0218835 A1
(43) Pub. Date: Sep. 8, 2011

(54) CHANGING PRIORITY LEVELS WITHIN A CONTROLLABLE TRANSIT SYSTEM

(75) Inventors: Gregory J. Boss, Saginaw, MI (US); Christopher J. Dawson, Arlington, VA (US); Rick A. Hamilton, II, Charlottesville, VA (US); Benjamin G. Morris, Falls Church, VA (US)

(73) Assignee: International Business Machines Corporation, Armonk, NY (US)

(21) Appl. No.: 12/715,457

(22) Filed: Mar. 2, 2010

(51) Int. Cl. G06Q 10/00; G01C 21/00; G06Q 30/00

(52) U.S. Cl. 705/7.26; 701/200

(57) ABSTRACT

Embodiments of the present invention provide for the changing/updating of priority levels within a controllable transit system. Specifically, vehicles and/or users thereof will be assigned a particular service level using any number of factors. Based on this service level, as well as any transit criteria specified, a route to a desired destination will be computed. Typically, the higher the service level assigned, the higher the priority that will be given to the particular vehicle/user. Under the present invention, the priority level of a vehicle/user can be changed (e.g., increased) upon request to result in an improved transit time and/or route to the desired destination. Examples of types of requests that may result in an increased priority level (but are not limited to) are: (1) payment of a fee for increased priority level; (2) trading priority levels with other vehicle/users; and (3) bidding in an auction-like environment for an improved priority level; etc.

### CROSS-REFERENCE TO RELATED APPLICATION

This application is related in some aspects to commonly-owned and co-pending application Ser. No. 12/715,435, entitled “SERVICE CLASS PRIORITIZATION WITHIN A CONTROLLABLE TRANSIT SYSTEM”, having attorney docket number END920090129US1, the entire contents of which are herein incorporated by reference.

### TECHNICAL FIELD

The present invention generally relates to transit systems (e.g., Personal Rapid Transit (PRT) systems). Specifically, the present invention relates to changing/updating priority levels (e.g., of user and/or vehicles) within a controllable transit system.

### BACKGROUND

As energy conservation becomes an increasingly important goal, one area of possible improvement is traffic and/or transportation management. Today, a traveler's options are typically limited to either an individual mode of transportation (e.g., an automobile), or mass transit (e.g., airplanes, subways, buses, trains, etc.). Neither option is entirely efficient. As a result, the more recent concept of “Personal Rapid Transit” (PRT) has emerged. PRT is a public transportation concept that offers on-demand, non-stop transportation using small, automated vehicles on a network of specially-built guide-ways. However, several issues stand in the way of efficient management of PRT systems.

### SUMMARY

In general, embodiments of the present invention provide for the changing/updating (these two terms may be used interchangeably throughout this disclosure herein) of priority levels within a controllable transit system. Specifically, vehicles and/or users thereof will be assigned a particular service level using any number of factors. Based on this service level, as well as any transit criteria specified, a route to a desired destination will be computed. Typically, the higher the service level assigned, the higher the priority that will be given to the particular vehicle/user. Under the present invention, the priority level of a vehicle/user can be changed (e.g., increased) upon request to result in an improved transit time and/or route to the desired destination.

Examples of types of requests that may result in an increased priority level (but are not limited to) are: (1) payment of a fee for increased priority level; (2) trading priority levels with other vehicle/users; and (3) bidding in an auction-like environment for an improved priority level; etc. It is understood that these concepts could also be used to reduce or trade down a priority level. For example, a user/vehicle already having a high priority level that is not immediately needed may be able to trade the higher priority level for a lower priority level in exchange for some compensation (e.g., financial, a higher priority level at a future date, etc.).

A first aspect of the present invention provides a method for changing priority levels within a controllable transit system, comprising: computing an initial route for a vehicle within the controllable transit system, the route being based on a priority level of the vehicle, the priority level being based on a service class of the vehicle; receiving a request to change the priority level; and changing the priority level in response to the request.

A second aspect of the present invention provides a system for changing priority levels within a controllable transit system, comprising: a memory medium comprising instructions; a bus coupled to the memory medium; and a processor coupled to the bus that when executing the instructions causes the system to: compute an initial route for a vehicle within the controllable transit system, the route being based on a priority level of the vehicle, the priority level being based on a service class of the vehicle; receive a request to change the priority level; and change the priority level in response to the request.

A third aspect of the present invention provides a computer readable medium containing a program product for changing priority levels within a controllable transit system, the computer readable medium comprising: program code for causing a computer to: compute an initial route for a vehicle within the controllable transit system, the route being based on a priority level of the vehicle, the priority level being based on a service class of the vehicle; receive a request to change the priority level; and change the priority level in response to the request.

A fourth aspect of the present invention provides a method for deploying a system for changing priority levels within a controllable transit system, comprising: providing a computer infrastructure being operable to: compute an initial route for a vehicle within the controllable transit system, the route being based on a priority level of the vehicle, the priority level being based on a service class of the vehicle; receive a request to change the priority level; and change the priority level in response to the request.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative vehicle within a controllable transit system according to the present invention.

FIG. 2 shows a method flow diagram according to an embodiment of the present invention.

FIG. 3 shows a more specific computerized implementation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

For convenience, the Detailed Description has the following sections:

I. General Description

II. Computerized Implementation

### I. General Description

In general, embodiments of the present invention provide for the changing/updating of priority levels within a controllable transit system. Specifically, vehicles and/or users thereof will be assigned a particular service level using any number of factors. Based on this service level, as well as any transit criteria specified, a route to a desired destination will be computed. Typically, the higher the service level assigned, the higher the priority that will be given to the particular vehicle/user. Under the present invention, the priority level of a vehicle/user can be changed (e.g., increased) upon request to result in an improved transit time and/or route to the desired destination.

It is understood that the priority level of a vehicle/user is typically based on its service class. This is not to say, however, that priority level and service class are the same. Rather, priority levels can help distinguish between vehicles that are in the same service class. Along these lines, it is possible for two vehicles to have the same service class but different priority levels. For example, vehicle A carrying the mayor and vehicle B carrying the deputy mayor may be in the same service class. However, given the hierarchy of the users therein, vehicle A may be given a higher priority level.

Examples of types of requests that may result in an increased priority level (but are not limited to) are: (1) payment of a fee for increased priority level; (2) trading priority levels with other vehicle/users; (3) bidding in an auction-like environment for an improved priority level; etc. It is understood that these concepts could also be used to reduce or trade down a priority level. For example, a user/vehicle already having a high priority level that is not immediately needed may be able to trade the higher priority level for a lower priority level in exchange for some compensation (e.g., financial, a higher priority level at a future date, etc.).

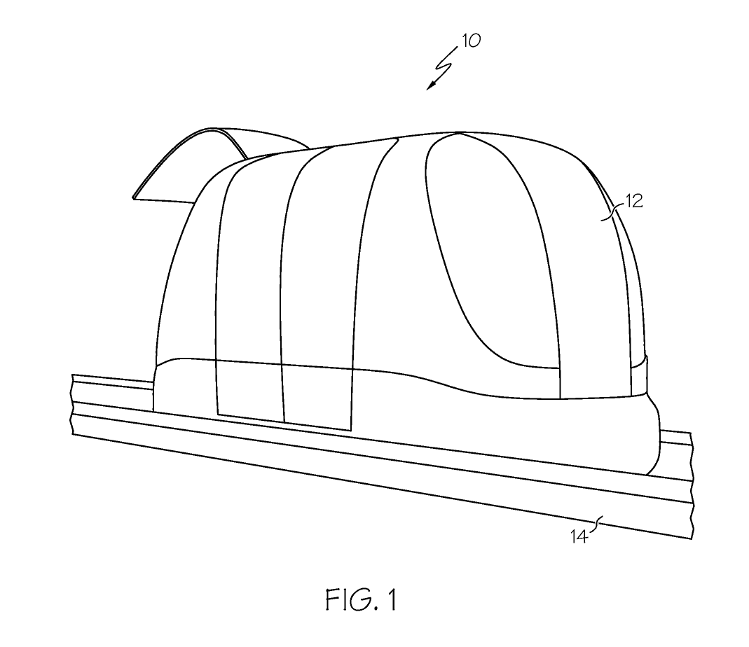

An illustrative controllable transit system 10 is depicted in FIG. 1. As shown, system 10 generally comprises a vehicle 12 or the like that is mounted on a rail 14 or the like. Although only one vehicle 12 and one rail 14 are depicted in FIG. 1 for simplicity purposes, it is understood that system 10 can actually comprise any quantity of vehicles and/or rails. Additional rails allow for vehicles to be passed and/or pulled over (e.g., to allow for emergency vehicles to pass by). In any event, system 10 can be thought of as a hybrid between a highly occupied mode of transportation with fixed stops (e.g., subway, bus, etc.), and an individual mode of transportation with destination specific stops (e.g., a taxicab). Along these lines, vehicle 12 can transport one or more users to specific stops along rail 14. It should be understood that although illustrative embodiments of the invention as described herein pertain to a PRT system, this need not be the case. Rather, the teachings recited herein could be implemented in conjunction with any type of controllable transit/transport system now known or later developed.

Along these lines, aspects of the present invention allow a user (e.g., in real time) to change their routing priorities (e.g., update/change the priority level) for a PRT vehicle. The invention is also equally applicable to first time or initial reservations. Such reprioritization is reflected in subsequent routing decisions as the vehicle makes its way toward an ultimate destination. The subsequent routing decisions could be adjusted in real-time based on any type of request such as the following:
1. an initial purchase of a higher priority level (e.g., a faster route);
2. a manual upgrade of an existing route (e.g., prior to or while in transit); and/or
3. a desired time of arrival (DTA).

This can be accomplished through an entry device, choice of a priority level, optionally an estimate of the time savings achieved by escalating priority levels, and a payment mechanism. The basic bidding system entails a one-time bid that occurs at the time the route is requested. The bid considers a point in time spot market showing what routing choices are currently available. Along these lines, the following examples can be implemented hereunder.

### Example 1

A user who is already in the PRT vehicle is about to be late for an appointment and chooses to pay a premium for his or her routing service class to be upgraded. Subsequently, that user sees faster transportation from that point in time to the destination than would the user who chooses not to pay for this PRT upgrade.

### Example 2

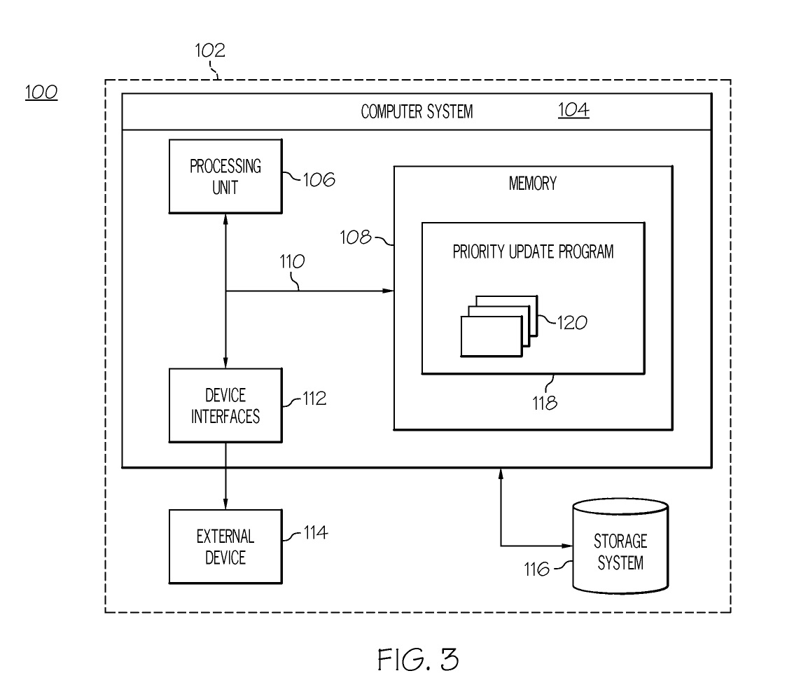

A user is waiting for a PRT vehicle at a collection point to take him to a customer meeting. It is cold out and he does not want to wait any longer, so he opens up a PRT application on his cell phone and places a bid to upgrade his route service class to a VIP class. The bid is successful and a PRT vehicle is rerouted to arrive sooner than originally scheduled. This embodiment could involve a bidding engine (e.g., embodied within priority update program 118 of FIG. 3 below).

### Example 3

A user is waiting for a PRT vehicle at a collection point to take him to a meeting. He gets a message saying the meeting has been scheduled 30 minutes earlier than planned. While waiting, the user opens up a PRT application on his cell phone and places a DTA request (desired time of arrival). The application returns several upgraded routing options with associated prices. These upgraded routing options will meet the user's new DTA requirements but will mean an increase in price. The user selects one that will get him to his destination 35 minutes before the meeting.

Implementation of real-time bidding for priority routing in a PRT system would require the following components: data store, auction application, wireless connectivity to the PRT, user interfaces exposed within the PRT vehicle as well as through mobile handheld devices, and a routing engine.

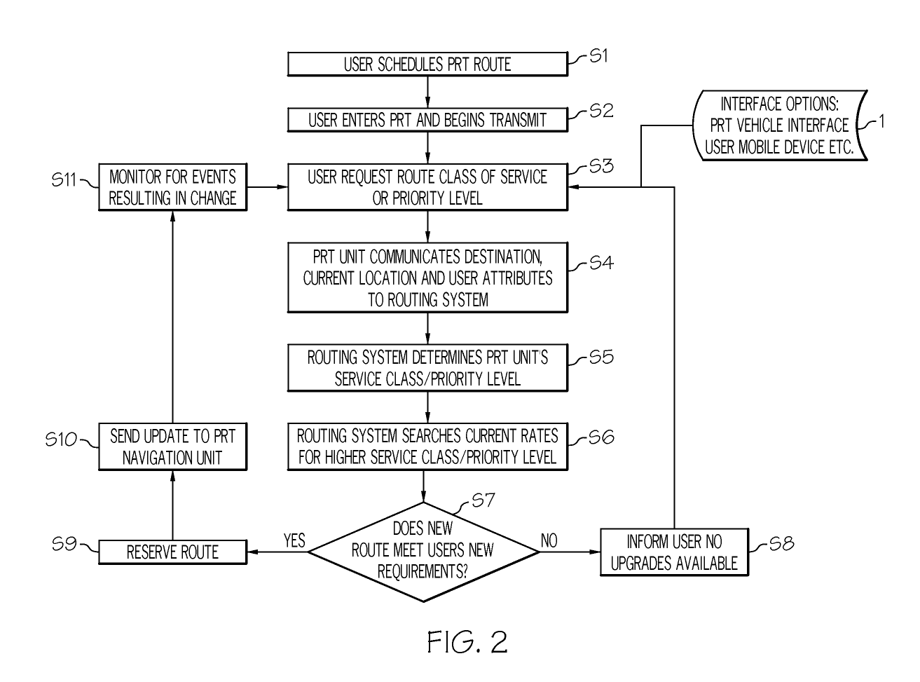

The diagram shown in FIG. 2 represents a typical process flow where a user can realize the advantages described in the invention. For illustrative purposes only, FIG. 2 depicts a use case as outlined in Example 1 above wherein a user is already in a PRT vehicle enroute to a destination. In this example, it is assumed that while in transit, the user chooses to upgrade to a higher service or priority level to achieve some advantage (preferred route, faster time, greener route, etc).

In step S1, the user schedules a route. In step S2, the user enters the vehicle and begins transit. In step S3, the user requests an upgrade to a higher service class and/or priority level. As shown, this can be done via an interface ‘I’ within the vehicle. Regardless, in step S4, the desired destination, current location, and user attributes are communicated to the routing system. In step S5, the routing system determines the vehicle's service class and corresponding priority level. In step S6, the routing system searches current rates and routes for a higher service class and/or priority level. In step S7, it is determined whether the new route meets the user's requirements (also referred to herein as transit criteria (e.g., a desired time of arrival or transit time). If not, the user is informed that no upgrades are available in step S8. If so, the new route is reserved in step S9, and an update is sent to the vehicle's navigation unit in step S10. Throughout the process, the system is monitored in step S11 for events that may lead to a change of service class or priority level.

Slight variations of the above process flow will be obvious to the person implementing the system. One such variation would be the implementation of the bidding system prior to the user entering the PRT Vehicle. Another variation would be to allow the user to enter a desired time or arrival (DTA) and let the system determine if there are any existing auctions or real-time upgrades available for purchase. Along these lines, a bidding engine would have the responsibility to determine excess capacity and to dynamically create auctions which users can participate in to achieve higher classes of service. The bidding engine interacts with the routing system and can proactively or reactively generate the auctions. In one embodiment, the bidding engine can determine excess capacity. Shown below are various auction techniques that can be implemented hereunder.

### Method to Proactively Create an Auction

Utilizing this data, the engine could display proactive messages to PRT users throughout the system informing them that there is an auction underway to upgrade their route to a higher class of service. The user could then opt to participate or decline.

### Method to Reactively Create an Auction

Another method would entail a different process, closer to that described in FIG. 1 wherein the user would initiate a request to upgrade their route via an input mechanism in the PRT vehicle or using a mobile connected device. This would trigger a request for the bidding engine to reactively create an auction using excess capacity in the PRT routing system.

Moreover, a real-time bidding system could be a system where a user allocates X money and lets the system spend Y (where Y is less than X) every few minutes in order to beat enough other bidders, to achieve Class A preferences. For example, this might assume an auction takes place every 5 minutes and, over the course of a 50-mile trip, the user might encounter 10 or 15 auctions. The system could optimally allocate the user's total budget among the 15 auctions, but only enough to get the best class of service in each auction. This option for “real-time bidding” is even more dynamic than the idea broadly outlined here, and may be considered as a “spin off” if broad enough.

### II. Computerized Implementation

Referring now to FIG. 3, a computerized implementation 100 of the present invention is shown. As depicted, implementation 100 includes a computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

As shown, computer system 104 includes a processing unit 106, a memory 108, a bus 110, and a device interfaces 112. Further, computer system 104 is shown having external devices 114 and storage system 116 that communicate with bus 110 via device interfaces 112. In general, processing unit 106 executes computer program code, such as priority update software/program 118, which is stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 could also include I/O interfaces that communicate with: one or more external devices such as: a keyboard, a pointing device, a display, etc.; one or more devices that enable a user to interact with computer system 104; and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various processes of the invention. Moreover, computer system 104 is only representative of various possible computer systems that can include numerous combinations of hardware. To this extent, in other embodiments, computer system 104 can comprise any specific purpose-computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations (e.g., on a client and server). Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 3 can be included in computer system 104.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN), or a storage area network (SAN) (not shown). In addition, although not shown, additional components, such as cache memory, communication systems, system software, etc., may be incorporated into computer system 104.

Shown in memory 108 of computer system 104 is priority update program 118 having a set of modules 120. The modules 120 generally provide the functions of the present invention as described herein. Specifically (among other things), set of modules 120 is configured to: determine a set of routing options based on the request; return the set of routing options to a sender of the request; compute an initial route for a vehicle within the controllable transit system, the route being based on a priority level of the vehicle; receive a request to change the priority level; and/or change the priority level in response to the request. Along these lines, priority update program 118 is also configured to manage any auction activities such as receiving bids, handling responses accepting or rejecting the bids, etc. As such, priority update program 118 should be understood to include an auction engine or the like.

While shown and described herein as a priority update solution, it is understood that the invention further provides various alternative embodiments. For example, in one embodiment, the invention provides a computer-readable/useable medium that includes computer program code to enable a computer infrastructure to provide a priority update solution. To this extent, the computer-readable/useable medium includes program code that implements each of the various process of the invention. It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 3) and/or storage system 116 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process of the invention on a subscription, advertising, and/or fee basis. That is, a service provider, such as a Solution Integrator, could offer to provide a priority update solution. In this case, the service provider can create, maintain, support, etc., a computer infrastructure, such as computer infrastructure 102 (FIG. 3) that performs the process of the invention for one or more customers. In return, the service provider can receive payment from the customer(s) under a subscription and/or fee agreement and/or the service provider can receive payment from the sale of advertising.

In still another embodiment, the invention provides a computer-implemented method for priority change within a controllable transit system such as a PRT. In this case, a computer infrastructure, such as computer infrastructure 102 (FIG. 3), can be provided, and one or more systems for performing the process of the invention can be obtained (e.g., created, purchased, used, modified, etc.) and deployed to the computer infrastructure. To this extent, the deployment of a system can comprise one or more of: installing program code on a computing device, such as computer system 104 (FIG. 3), from a computer-readable medium; adding one or more computing devices to the computer infrastructure; and incorporating and/or modifying one or more existing systems of the computer infrastructure to enable the computer infrastructure to perform the process of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for changing priority levels within a controllable transit system, comprising:
computing an initial route for a vehicle within the controllable transit system, the route being based on a priority level of the vehicle, the priority level being based on a service class of the vehicle;
receiving a request to change the priority level; and
changing the priority level in response to the request.

2. The method of claim 1, further comprising reducing a time in which the vehicle will take to reach a destination based on the changing.

3. The method of claim 1, further comprising changing the initial route based on the changing.

4. The method of claim 1, the request comprising a financial offer for upgrading the priority level to a high priority level.

5. The method of claim 1, the request comprising a bid for upgrading the priority level to a higher level, the method further comprising receiving responses to either accept or reject the bid.

6. The method of claim 1, further comprising:
determining a set of routing options based on the request; and
returning the set of routing options to a sender of the request.

7. The method of claim 6, the set of routing options affecting at least one of the following: the initial route, or a travel time of the vehicle.

8. A system for changing priority levels within a controllable transit system, comprising:
a memory medium comprising instructions;
a bus coupled to the memory medium; and
a processor coupled to the bus that when executing the instructions causes the system to:
compute an initial route for a vehicle within the controllable transit system, the route being based on a priority level of the vehicle, the priority level being based on a service class of the vehicle;
receive a request to change the priority level; and
change the priority level in response to the request.

9. The system of claim 8, the memory medium further comprising instructions that when executed by the processor further causes the system to reduce a time in which the vehicle will take to reach a destination based on the changing.

10. The system of claim 8, the memory medium further comprising instructions that when executed by the processor further causes the system to change the initial route based on the changing.

11. The system of claim 8, the request comprising a financial offer for upgrading the priority level to a high priority level.

12. The system of claim 8, the request comprising a bid for upgrading the priority level to a higher level, the memory medium further comprising instructions that when executed by the processor further causes the system to receive responses to either accept or reject the bid.

13. The system of claim 8, the memory medium further comprising instructions that when executed by the processor further causes the system to determine a set of routing options based on the request; and
return the set of routing options to a sender of the request.

14. The system of claim 13, the set of routing options affecting at least one of the following: the initial route, or a travel time of the vehicle.

15. A computer readable medium containing a program product for changing priority levels within a controllable transit system, the computer readable medium comprising program code for causing a computer to:
compute an initial route for a vehicle within the controllable transit system, the route being based on a priority level of the vehicle, the priority level being based on a service class of the vehicle;
receive a request to change the priority level; and
change the priority level in response to the request.

16. The computer readable medium containing the program product of claim 15, the computer readable medium further comprising program code for causing the computer to reduce a time in which the vehicle will take to reach a destination based on the changing.

17. The computer readable medium containing the program product of claim 15, the computer readable medium further comprising program code for causing the computer to change the initial route based on the changing.

18. The computer readable medium containing the program product of claim 15, the request comprising a financial offer for upgrading the priority level to a high priority level.

19. The computer readable medium containing the program product of claim 15, the request comprising a bid for upgrading the priority level to a higher level, the computer readable medium further comprising program code for causing the computer to receive responses to either accept or reject the bid.

20. The computer readable medium containing the program product of claim 19, the computer readable medium further comprising program code for causing the computer to:
determine a set of routing options based on the request; and
return the set of routing options to a sender of the request.

21. The computer readable medium containing the program product of claim 13, the set of routing options affecting at least one of the following: the initial route, or a travel time of the vehicle.

22. A method for deploying a system for changing priority levels within a controllable transit system, comprising:
providing a computer infrastructure being operable to:
compute an initial route for a vehicle within the controllable transit system, the route being based on a priority level of the vehicle, the priority level being based on a service class of the vehicle;
receive a request to change the priority level; and
change the priority level in response to the request.

23. The method of claim 22, the computer infrastructure being further operable to:
determine a set of routing options based on the request; and
return the set of routing options to a sender of the request.
